(19) United States
(12) Patent Application Publication
(10) Pub. No.: US 2018/0306155 A1
(43) Pub. Date: Oct. 25, 2018

(54) Fuel Injection Valve

(71) Applicant: Hitachi Automotive Systems, Ltd., Hitachinaka-shi, Ibaraki (JP)

(72) Inventors: Mitsuhiro MATSUZAWA, Tokyo (JP); Kazuki YOSHIMURA, Tokyo (JP); Eiji ISHII, Tokyo (JP); Akihiro YAMAZAKI, Hitachinaka-shi (JP); Takahiro SAITO, Hitachinaka-shi (JP); Nobuaki KOBAYASHI, Hitachinaka-shi (JP)

(21) Appl. No.: 15/779,402

(22) PCT Filed: Sep. 21, 2016
(86) PCT No.: PCT/JP2016/077839

§ 371 Date: May 25, 2018

(30) Foreign Application Priority Data
Nov. 26, 2015 (JP) 2015-230559

(51) Int. Cl. F02M 61/18

(52) U.S. Cl. CPC F02M 61/1813; F02M 61/1833; F02M 61/182; F02M 61/1886

(57) ABSTRACT

It is an object of the present invention to provide a fuel injection valve that can increase the collision force of the fuel with respect to the injection hole inner wall surface and which can realize a sufficient atomization. In an imaginary plane orthogonal to a center axis line direction of a valve body, a plurality of injection holes through and through constituting a first injection hole set are formed such that an injection hole center axis extending from an injection hole inlet surface toward an injection hole outlet surface is formed to extend in a direction different from that of a straight line connecting the origin of an imaginary orthogonal coordinate system formed by an imaginary X-axis and an imaginary Y-axis and the center of an injection hole inlet surface and that the center of an injection hole outlet surface is situated close to the imaginary X-axis with respect to the center of the injection hole inlet surface.

### TECHNICAL FIELD

The present invention relates to a fuel injection valve used in an internal combustion engine such as a gasoline engine and to a fuel injection valve which prevents leakage of fuel by bringing a valve body into contact with a valve seat and which performs injection by bringing the valve body out of contact with the valve seat.

### BACKGROUND ART

In recent years, emission control for automobiles has become strict. In correspondence with this strict emission control, atomization and accurate spraying direction are required of the spraying of a fuel injection valve mounted in an automotive internal combustion engine. Through atomization of the spraying, it is possible to enhance fuel economy. Further, by emitting the spray at aimed positions (e.g., in two directions of the intake valve, it is possible to suppress adhesion of the spray to the wall surface of an intake pipe or the like.

For example, Patent Document 1 discloses a fuel injection valve capable of forming two sprays of satisfactory penetration property. In the fuel injection valve of Patent Document 1, a plurality of fuel injection holes are divided into first and second fuel injection hole sets, with a plane including the axis of the valve hole serving as a boundary. Two spray forms are formed by the fuel ejected from the first and second fuel injection hole sets. In this fuel injection valve, all the fuel injection holes of the first and second sets are formed in the same diameter, and second center lines of the fuel injection holes situated on both outer sides of the sets are inclined toward the front side of an injector plate so as to approach the center of each set or a first center line of the fuel injection hole situated in the vicinity thereof (see the Abstract).

### PRIOR ART DOCUMENT

### Patent Document

Patent Document 1: JP-2010-236392-A

### SUMMARY OF THE INVENTION

### Problem to be Solved by the Invention

The main mechanism of atomization in an ordinary nozzle plate is as follows.

When the fuel flows into a fuel injection hole (hereinafter referred to as the injection hole), the fuel collides with the inner wall of the injection hole, and there is induced a flow having a large velocity component in a plane perpendicular to the center axis (center line) of the injection hole.

That is, the velocity component in the peripheral direction and the radial direction of the injection hole becomes larger. Hereinafter, this velocity component will be referred to as the in-plane velocity component. On the other hand, the velocity component in the center axis direction of the injection hole will be referred to as the axial velocity component.

Due to this in-plane velocity component, the fuel is easily expanded on the downstream side of the injection hole, and the atomization is promoted.

Thus, the magnitude of this in-plane velocity component greatly affects the atomization of the spray. That is, the larger the force with which the fuel collides with the inner wall surface of the injection hole, the larger the in-plane velocity component, and the more promoted is the atomization.

In the fuel injection valve disclosed in Patent Document 1, however, a plurality of injection holes are divided into two injection hole sets (first and second sets of fuel injection hole sets). Further, in each injection hole set, the injection holes other than both outer sides are arranged such that the extensions of the center axes are parallel and that they are inclined so as to move away from a plane passing the axis of the valve hole of the valve seat member toward the spraying direction to extend in the Y-direction (the boundary direction of the two injection hole sets). In this case, the angle made by the flowing direction of the fuel toward the inlet of the injection hole and the inclination direction of the injection hole (the direction of the center axis) is small. Thus, the collision force (pressing force) of the fuel with respect to the injection hole inner wall is diminished, which hinders the atomization of the spray.

It is an object of the present invention to provide a fuel injection valve which can increase the collision force of the fuel with respect to the injection hole inner wall surface and which can realize a sufficient atomization.

### Means for Solving the Problem

To achieve the above object, an typical example of the present invention provides a fuel injection valve including a valve body that can be displaced in a center axis line direction, a valve seat opening and closing a fuel path in cooperation with the valve body, and a plurality of injection holes provided on a downstream side of the valve seat and configured to eject a fuel having passed through the fuel path to exterior, in which the fuel ejected from the plurality of injection holes of a first injection hole set formed by a plurality of injection holes being at least a part of the plurality of injection holes forms as a whole a first fuel spray directed in a first spraying direction, in which

supposing that the plurality of injection holes constituting the first injection hole set and the first spraying direction in which the first fuel spray is directed are projected on an imaginary plane orthogonal to the center axis line direction, and that an imaginary orthogonal coordinate system which has an imaginary X-axis extending along the first spraying direction and an imaginary Y-axis orthogonal to the imaginary X-axis and which has an origin coinciding with a projection center point obtained through projection of the center axis line onto the imaginary plane is imagined in the imaginary plane, then,

in the imaginary plane, the plurality of injection holes constituting the first injection hole set are formed such that an injection hole center axis extending from an inlet surface toward an outlet surface of the injection hole is formed to extend in a direction different from that of a straight line connecting the origin of the imaginary orthogonal coordinate system and a center of the inlet surface and that a center of the outlet surface is situated close to the imaginary X-axis with respect to the center of the inlet surface.

### Effect of the Invention

According to the present invention, it is possible to provide a fuel injection valve which can increase the collision force of the fuel with respect to the injection hole inner wall surface and which can promote the atomization.

Objects, constructions, and effects other than those mentioned above will become apparent from the following description of embodiments.

### BRIEF DESCRIPTION OF THE DRAWINGS

FIG. 1 is a sectional view of a fuel injection valve according to a first embodiment of the present invention.

FIG. 2 is an enlarged sectional view of the portion in the vicinity of the distal end portion of the valve body of the fuel injection valve of the first embodiment of the present invention.

FIG. 3 is a diagram illustrating a nozzle plate of the fuel injection valve of the first embodiment of the present invention as seen from the valve body side.

FIG. 4 is a diagram illustrating the spraying mode of the fuel injection valve of the first embodiment of the present invention as seen from the Y-axis direction.

FIG. 5 is a diagram illustrating the spraying mode of the fuel injection valve of the first embodiment of the present invention as seen from the X-axis direction.

FIG. 6 is a diagram illustrating the nozzle plate of a fuel injection valve according to a first comparative example of the present invention as seen from the valve body side.

FIG. 7 is a diagram illustrating a flowing place in the vicinity of an injection hole of the fuel injection valve of the first comparative example of the present invention.

FIG. 8 is a diagram illustrating the nozzle plate of a fuel injection valve according to a second comparative example of the present invention as seen from the valve body side.

FIG. 9 is a diagram illustrating a flowing place in the vicinity of an injection hole of the fuel injection valve of the second comparative example of the present invention.

FIG. 10 is an enlarged view of the portion in the vicinity of the injection hole when the nozzle plate of the fuel injection valve according to the first embodiment of the present invention is seen from the valve body side.

FIG. 11 is a schematic diagram illustrating the relationship between the inclination angle of the injection hole and the spray interference distance as seen in the section B-B of FIG. 3.

FIG. 12 is a diagram illustrating the nozzle plate of the fuel injection valve according to the second embodiment of the present invention as seen from the valve body side.

FIG. 13 is an enlarged sectional view of the portion in the vicinity of the distal end portion of the valve body of the fuel injection valve according to a third embodiment of the present invention.

FIG. 14 is an enlarged sectional view of the portion in the vicinity of the distal end portion of the valve body of the fuel injection valve according to a fourth embodiment of the present invention.

FIG. 15 is a diagram illustrating the nozzle plate of the fuel injection valve according to a fifth embodiment of the present invention as seen from the valve body side.

### MODES FOR CARRYING OUT THE INVENTION

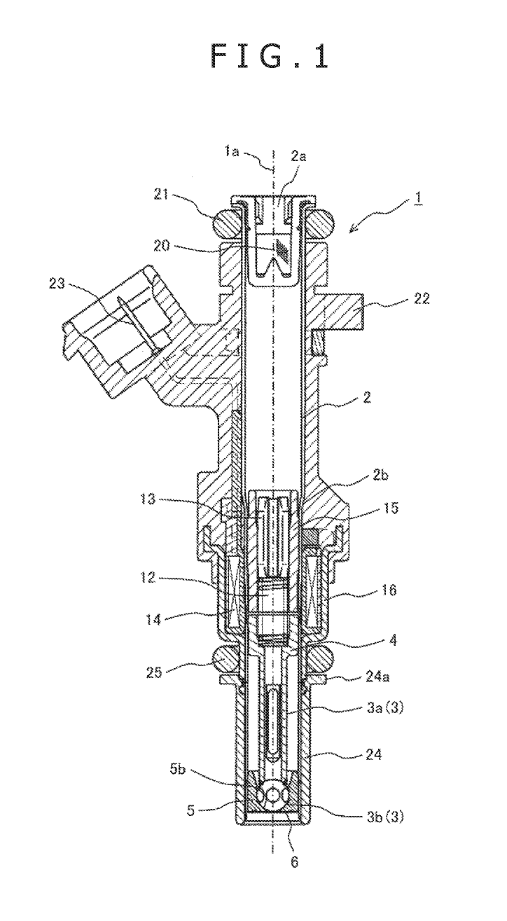

In the following, an embodiment of the present invention will be described with reference to the drawings. In the following direction, the up-down direction will be defined based on FIG. 1. This up-down direction has nothing to do with the up-down direction when a fuel injection valve 1 is mounted on an engine. Further, the fuel supply port 2a side (upper end side) of the fuel injection valve 1 will be referred to as the proximal end side, and the nozzle plate 6 side (lower end side) will be referred to as the distal end side. This is based on the fact that the fuel supply port 2a side is connected to fuel piping (not shown) to receive the supply of the fuel.

### Embodiment 1

In the following, the first embodiment of the present invention will be described with reference to FIGS. 1 through 11.

FIG. 1 is a sectional view of the fuel injection valve 1 according to the first embodiment of the present invention.

In FIG. 1, the fuel injection valve 1 supplies a fuel, for example, to an internal combustion engine used as an automotive engine. A casing 2 is formed by stamping, cutting or the like in a cylindrical configuration which is thin and narrow and which has a thin-walled portion. The casing 2 has a step portion 2b at an intermediate portion between both end portions, and is formed as a cylinder that is integral substantially from the proximal end portion to the distal end portion of the fuel injection valve 1. The material employed is obtained by adding a flexible material such as titanium to a ferrite type stainless steel material, and has a magnetic characteristic.

Provided at one end surface (upper end surface) of the casing 2 is a fuel supply port 2a, and provided at the other end surface (lower end surface) thereof is a nozzle plate 6 having a plurality of fuel injection holes (injection holes). The nozzle plate 6 is fixed to a nozzle body 5.

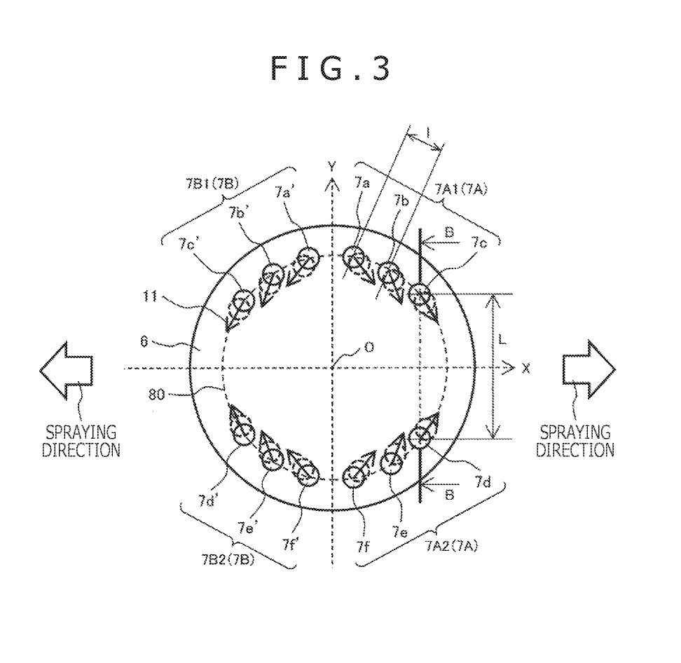

The nozzle plate 6 has holes 7 for ejecting fuel (hereinafter referred to as the injection holes) (see FIG. 3). On the outer side of the casing 2 of FIG. 1, there are provided a solenoid coil 14 and a yoke 16 of a magnetic material surrounding the solenoid coil 14. On the inner side of the casing, there are provided a stationary core 15, an anchor 4, a valve body 3, a nozzle body 5, and the nozzle plate 6.

The stationary core 15 is inserted into the casing 2, and is then arranged on the inner side of the solenoid coil 14.

The anchor 4 has a gap between itself and the distal end side end surface of the stationary core 15, and is opposite the distal end side end surface. The anchor 4 is mounted so as to be capable of displacement in the axial direction (the center axis line 1a direction) together with the valve body 3 described below. The anchor 4 is produced through injection molding such as MIM (Metal Injection Molding) using a metal powder consisting of a magnetic material.

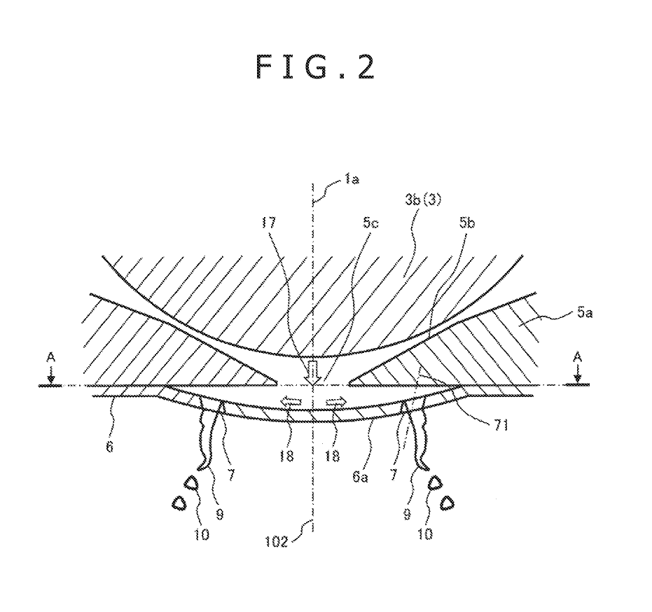

The valve body 3 is formed integrally with the anchor 4, and has a hollow rod portion 3a extending in the center axis 102 direction (see FIG. 2), and a ball valve portion 3b fixed to the distal end portion of the rod portion 3a. The valve body 3 may be formed as a member separate from the anchor 4. The valve body 3 and the anchor 4 constitute a needle, which is capable of displacement along the center axis 102.

Nozzle body 5 is provided at the distal end side of the valve body 3 and at the proximal end side of the nozzle plate 6. The nozzle body 5 is inserted into the distal end portion of the casing 2, and is fixed to the casing 2 through welding.

There is formed a valve seat surface 5b on which the distal end (the ball valve portion 3b) of the valve body 3 is seated.

The portions of the valve seat surface 5b and the ball valve portion 3b which are in contact with each other constitute a seat portion. When the ball valve portion 3b comes into contact with the valve seat surface 5b, the fuel path is closed, and when the ball valve portion 3b is spaced away from the valve seat surface 5b, the fuel path is opened. That is, the valve body 3 and the valve seat surface (valve seat) 5b cooperate with each other to open and close the fuel path of the seat portion. In some cases, the seat portion of the valve seat surface 5b is referred to as the valve seat. In the present embodiment, there is no need in particular to distinguish the valve seat surface 5b and the seat portion from each other, and the valve seat may be either of the valve seat surface 5b and the seat portion.

The nozzle plate 6 is arranged at the distal end side end surface of the nozzle body 5. The nozzle plate 6 is provided with a plurality of injection holes 7 formed so as to extend through it in the thickness direction. The injection holes 7 are provided on the downstream side of the valve seat surface 5b, and eject the fuel having passed through the fuel path of the seat portion to the exterior. The surface of the nozzle plate 6 in contact with the nozzle body 5 is bonded through welding.

In FIG. 1, inside a through-hole extending through the central portion of the core 15, there is arranged a spring 12 as an elastic member. The spring 12 provides a force (urging force) with which the distal end (seat portion) of the valve portion 3b of the valve body 3 against the seat portion of the valve seat surface 5b of the nozzle body 5. On the fuel supply port 2a side of the spring 12 (the side opposite the anchor 4), there is arranged a spring adjuster 13 continuous with the spring 12 and adjusting the pressing force of the spring 12.

Further, arranged at the fuel supply port 2a is a filter 20, which removes foreign matter contained in the fuel. Further, mounted to the outer periphery of the fuel supply port 2a is an O-ring 21 for sealing the fuel supplied. In the vicinity of the fuel supply port 2a, there is provided a resin cover 22. The resin cover 22 is provided so as to cover the casing 2 and the yoke 16 by means such as resin molding. The resin cover 22 contains a connector 23 for supplying power to the solenoid coil 14.

A protector 24 is provided at the distal end portion of the fuel injection valve 1, and consists, for example, of a cylindrical member formed of a resin material or the like, covering the outer peripheral surface of the distal end side portion of the casing 2. At the upper end portion of the protector 2, there is formed a flange portion 24a protruding radially outwards from the outer peripheral surface of the casing 2. An O-ring 25 is attached to the outer periphery of the distal end side portion of the casing 2. The O-ring 25 is arranged between the yoke 16 and the flange portion 24a of the protector 24 so as to be prevented from detachment. When, for example, the distal end side portion of the casing 2 (the fuel injection valve 1) is mounted to a mounting portion (not shown) or the like provided in the intake pipe of the internal combustion engine, the O-ring 25 seals between the fuel injection valve 1 and the mounting portion.

In the fuel injection valve 1 constructed as described above, when the solenoid coil 14 is in the non-energized state, the distal end of the valve body 3 comes into close contact with the nozzle body 5 due to the pressing force of the spring 12. In this state, a gap, that is, a fuel path, is not formed between the valve body 3 and the nozzle body 5, so that the fuel having flowed in via the fuel supply port 2a remains within the casing 2.

When an electric current as an injection pulse is applied to the solenoid coil 14, a magnetic flux is generated in the magnetic circuit formed by the yoke 16, the core 15, and the anchor 4 formed of a magnetic material. Due to the electromagnetic force of the solenoid coil 14, the anchor 4 moves until it comes into contact with the lower end surface of the core 15. When the valve body 3 moves to the core 15 side together with the anchor 4, a fuel path is formed between the valve portion 3b of the valve body 3 and the valve seat surface 5b of the nozzle body 5. After having flowed in from the periphery of the valve portion 3b, the fuel inside the casing 2 is ejected from the fuel injection holes 7 (see FIG. 2)

The fuel injection amount is controlled as follows: in correspondence with the injection pulses intermittently applied to the solenoid coil 14, the valve body 3 (the valve portion 3b) is moved in the axial direction, whereby the timing of switching between the open state and the closed state is adjusted.

FIG. 2 is an enlarged sectional view of the portion ini the vicinity of the distal end of the valve body 3 of the fuel injection valve 1 of the first embodiment of the present invention. The principal components related to the present invention will be briefly described with reference to FIG. 2.

As shown in FIG. 2, a ball valve is used as the valve portion 3b of the valve body 3. As the ball 3b, there is employed, for example, a ball bearing steel ball that is a JIS product. The reason for adopting this ball is that it is of high circularity and mirror-finished, which is suitable in enhancing the seat property. Further, the ball can be mass-produced, which is means it is of low cost. When it is used as the valve body, the diameter of the ball ranges approximately 3 to 4 mm. This is for the purpose of achieving a reduction in the weight of the valve, which is used as a movable valve.

Further, in the nozzle body 5, the angle of the inclined surface (the valve seat surface 5b) including the seat position coming into close contact with the valve body 3 is approximately 90° (from 80° to 100°). This inclination angle is an optimum angle for polishing the portion around the seat position and enhancing the circularity (allowing the grinding machine to be used in the best condition). This angle helps to maintain a very high level of seat property with respect to the valve body 3. The nozzle body 5 having the inclined surface including the seat position is enhanced in hardness through quenching. Further, unnecessary magnetism is removed therefrom through demagnetization processing. Due to this valve body construction, an injection amount control free from fuel leakage is possible. Further, it is possible to provide a valve body structure superior in cost performance.

To be formed in a downwardly convex configuration, the nozzle plate 6 undergoes extrusion by a punch in the manufacturing process for forming a convex surface.

When the fuel injection valve 1 is in the closed state, the valve body 3 comes into contact with the valve seat surface 5b consisting of a conical surface provided on the nozzle body (the seat member) 5 bonded to the casing 2 by welding or the like to thereby maintain the fuel in the sealed state. The contact portion on the valve body 3 side is formed by a spherical surface, and the valve seat surface consisting of a conical surface and the spherical surface are substantially brought into line contact with each other.

When the valve body 3 is raised to generate a gap between the valve body 3 and the nozzle body 5, the fuel flows out through the gap, and, at the opening 5c of the nozzle body 5, collides with the upper surface of the nozzle plate 6 from the direction of the arrow 17.

Thereafter, as indicated by the arrows 18, the fuel flows from the center of the nozzle plate 6 radially outwards along the surface of the nozzle plate 6. In this process, due to the downwardly convex configuration of the nozzle plate 6, the velocity of the fuel near the surface of the nozzle plate 6 is high. Then, after passing through the injection holes 7, the fuel forms liquid films 9, which are divided into droplets 10 due to instability because of the capillary wave and the shearing force with respect to the air, thus attaining atomization of the fuel.

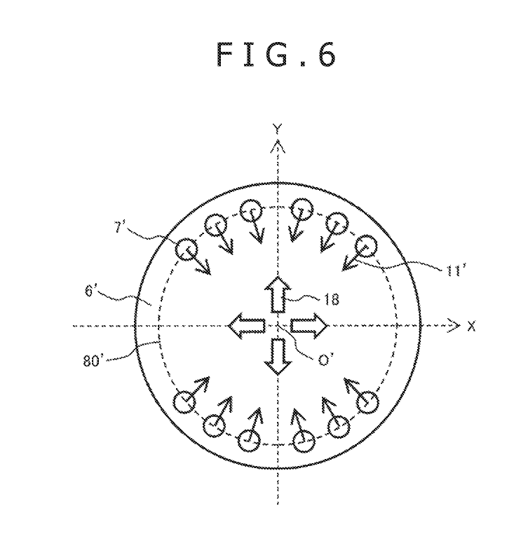

In FIG. 6, numeral 102 indicates the center axis (center axis line) of the nozzle plate 6 and of the valve body 3. In the present embodiment, the center axis 102 coincides with the center axis line 1a of the fuel injection valve. The lowermost protruded portion of the convex portion 6a of the nozzle plate 6 coincides with the center axis 102 and the center axis line 1a.

The configuration of the injection holes 7 of the present embodiment will be described in detail with reference to FIG. 3. FIG. 3 is a diagram illustrating the nozzle plate 6 of the fuel injection valve 1 of the first embodiment of the present invention as seen from the valve body 3 side. FIG. 3 is a plan view as seen from the section A-A of FIG. 2.

The axis passing the center O of the nozzle plate 6 and extending in the horizontal direction of FIG. 3 will be referred to as the X-axis (imaginary X-axis), and the axis passing the center O of the nozzle plate 6 and extending in the vertical direction of FIG. 3 will be referred to as the Y-axis (imaginary Y-axis). The X-axis and the Y-axis have the center O as the origin, and cross each other perpendicularly at the center O. FIG. 3 is a projection view (plan view) in which an imaginary orthogonal coordinate system formed by the X-axis and the Y-axis and injection holes 7a, 7b, 7c, 7d, 7e, 7f, 7a′, 7b′, 7c′, 7d′, 7e′, and 7f′ are projected onto an imaginary plane perpendicular to the center axis 102 and the center axis line 1a. Except for the description in which distinction is made in particular from the construction on the imaginary plane, the following description is based on the construction on this imaginary plane. The inclination direction of a center axis 71 and an arrow 11, an interval L, the injection hole intervals 1, etc. are also described based on the projection view projected on the imaginary plane.

Suppose that the region where X>0 and Y>0 is the first quadrant, that the region where X<0 and Y>0 is the second quadrant, that the region where X<0 and Y<0 is the third quadrant, and that the region where X> and Y<0 is the fourth quadrant. In the present embodiment, the injection holes 7a, 7b, and 7c are arranged in the first quadrant, the injection holes 7a′, 7b′, and 7c′ are arranged in the second quadrant, the injection holes 7d′, 7e′, and 7f′ are arranged in the third quadrant, and the injection holes 7d, 7e, and 7f are arranged in the fourth quadrant.

The injection hole set formed by the injection holes 7a, 7b, 7c, 7d, 7e, and 7f will be referred to as the first injection hole set 7A, and the injection hole set formed by the injection holes 7a′, 7b′, 7c′, 7d′, 7e′, and 7f′ will be referred to as the second injection hole set 7B. The injection holes 7a, 7b, 7c, 7d, 7e, and 7f of the first injection hole set 7A eject the fuel in a direction as a whole to form a first fuel spray. The injection holes 7a′, 7b′, 7c′, 7d′, 7e′, and 7f′ of the second injection hole set 7B eject the fuel in a direction different from that of the first injection hole set 7A as a whole to form a second fuel spray.

With the X-axis being the boundary, the first injection hole set 7A is divided into a first group 7A1 consisting of the injection holes 7a, 7b, and 7c, and a second group 7A2 consisting of the injection holes 7d, 7e, and 7f. With the X-axis being the boundary, the second injection hole set 7B is divided into a first group 7B1 consisting of the injection holes 7a′, 7b′, and 7c′, and a second group 7B2 consisting of the injection holes 7e′ and 7f′.

In the case where there is no need in particular to distinguish the injection holes 7a, 7b, 7c, 7d, 7e, 7f, 7a′, 7b′, 7c′, 7d′, 7e′, and 7f′ from each other, they will be simply referred to as injection holes (fuel injection holes) 7.

In FIG. 3, the positive direction of the X-axis coincides with the synthetic (total) ejecting direction of the spray ejected from the injection holes 7a through 7f arranged in the first injection hole set 7A, and the negative direction of the X-axis coincides with the synthetic (total) ejecting direction of the spray ejected from the injection holes 7a′ through 7f′ arranged in the second injection hole set 7B.

The arrows 11 indicate the inclination directions of the injection holes 7. That is, when the center axis 71 of each injection hole 7 (see FIG. 2) is projected onto the section A-A (plane), the projection line of the center axis 71 overlaps the arrow 11. The distal end side of the arrow 11 is on the downstream side, that is, the outlet side of the injection hole 7 in the fuel flowing direction.

The center axes 71 of the injection holes 7a, 7b, and 7c are inclined such that the X-coordinate of the injection hole outlet surface center is larger than the X-coordinate of the injection hole inlet surface center, and that the Y-coordinate of the injection hole outlet surface center is smaller than the Y-coordinate of the injection hole inlet surface center. The center axes 71 of the injection holes 7d, 7e, and 7f are inclined such that the X-coordinate of the injection hole outlet surface center is larger than the X-coordinate of the injection hole inlet surface center, and that the Y-coordinate of the injection hole outlet surface center is smaller than the Y-coordinate of the injection hole inlet surface center.

That is, in the present embodiment, in the imaginary plane of FIG. 3, the plurality of injection holes 7a through 7f constituting the first group 7A1 and the second group 7A2 of the first injection hole set 7A are formed such that each of the center axes 71 (see FIG. 2) of the injection holes 7a through 7f extending from the injection hole inlet surfaces (solid line) of the injection holes 7a through 7f toward the injection hole outlet surfaces (dotted line) extends in a direction different from the straight line connecting the origin O of the imaginary orthogonal coordinate system and the center of the injection hole inlet surface center. Further, the center axes 71 of the injection holes 7a through 7f are inclined such that the center of the injection hole outlet surface is close to the X-axis with respect to the center of the injection hole inlet surface.

In the present embodiment, the injection holes 7a, 7b, and 7c of the first injection hole set 7A are arranged such that the interval of the adjacent injection holes (the distance between the centers of the inlet surfaces) 1 is equal. Further, the injection holes 7a, 7b, and 7c are arranged in the circumference of an arrangement circle 80 the center of which is the center O of the nozzle plate 6 (the origin of the imaginary orthogonal coordinate system). Thus, the injection holes 7a, 7b, and 7c are arranged at equal angular intervals around the point O. The injection holes 7d, 7e, and 7f of the first injection hole set 7A are arranged such that the interval of the adjacent injection holes (the distance between the centers of the inlet surfaces) 1 is equal. Further, the injection holes 7d, 7e, and 7f are arranged in the circumference of the arrangement circle 80 the center of which is the center O of the nozzle plate 6 (the origin of the imaginary orthogonal coordinate system). Thus, the injection holes 7d, 7e, and 7f are arranged at equal angular intervals around the point O.

On the front side in the fuel injection direction, the injection holes 7a, 7b, and 7c of the first group 7A1 and the injection holes 7d, 7e, and 7f of the second group 7A2 are inclined such that the farther from the nozzle plate 6, the closer the center axes 71 of the injection holes (the arrows 11).

Of the injection holes 7a, 7b, and 7c of the first group 7A1, the injection hole 7c is arranged closest to the X-axis, and closest to the second group 7A2. Of the injection holes 7d, 7e, and 7f of the second group 7A2, the injection hole 7d is arranged closest to the X-axis, and closest to the first group 7A1. The interval L between the injection holes 7c and 7d adjacent to each other with the X-axis therebetween is larger than the interval 1 between the injection holes 7a, 7b, and 7c and the interval 1 between the injection holes 7f, 7e, and 7d of the first injection hole set 7A.

The interval L is the minimum of the distances between the centers of the inlet surfaces (inlet opening surfaces) of the injection holes 7a, 7b, and 7c of the first group 7A1 and the distances between the centers of the inlet surfaces (inlet opening surfaces) of the injection holes 7d, 7e, and 7f of the second group 7A2.

That is, in the present embodiment, the inter-group inter-hole distance L, which is the minimum of the inter-group inter-hole distances formed between the inlet surface centers of the injection holes of the plurality of injection holes 7a, 7b, 7c (7a′, 7b′, 7c′) constituting the first group 7A1 (7B1) and the plurality of injection holes 7d, 7e, 7f (7d′, 7e′, 7f′) constituting the second group 7A2 (7B2) is set to be larger than the maximum in-group inter-hole distance 1 of the in-group inter-hole distance 1 within the plurality of injection holes 7a, 7b, 7c (7a′, 7b′, 7c′) constituting the first group 7A1 (7B1) formed between the inlet surface centers of the plurality of injection holes 7a, 7b, 7c (7a′, 7b′, 7c′) and the in-group inter-hole distances 1 within the plurality of injection holes 7d, 7e, 7f (7d′, 7e′, 7f′) constituting the second group 7A2 (7B2) formed between the inlet surface centers of the plurality of injection holes 7d, 7e, 7f (7d′, 7e′, 7f′).

From a different point of view, the injection holes are arranged such that the inter-group distance in the injection hole sets 7A and 7B (the distance between the first group 7A1, 7B1 and the second group 7A2, 7B2) is larger than the maximum inter-hole distance (the maximum value of the inter-center distance of the injection hole inlet surface) of the injection holes 7a through 7c, 7d through 7f, 7a′ through 7c′, and 7d′ through 7f′ constituting the groups 7A1, 7B1, 7A2, and 7B2 in the injection hole sets 7A and 7B. Here, the distance between the first group 7A1, 7B1 and the second group 7A2, 7B2 is the inter-center distance between the inlet surfaces of the two injection holes arranged closest to each other between the groups.

The injection holes 7a′, 7b′, 7c′, 7d′, 7e′, and 7f′ are in plane symmetry with respect to a plane passing the injection holes 7a, 7b, 7c, 7d, 7e, and 7f, and the Y-axis and perpendicular to the plane of FIG. 3 (the plane including the Y-axis and the center axis line 1a, and the plane passing the Y-axis and perpendicular to the X-axis).

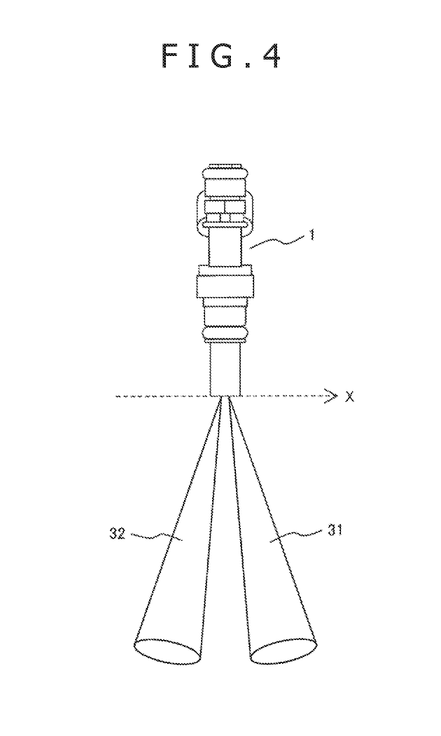

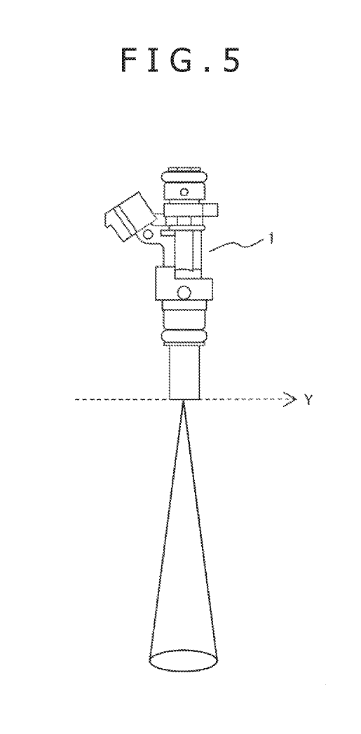

FIG. 4 is a diagram illustrating the spraying mode of the fuel injection valve of the first embodiment of the present invention as seen from the Y-axis direction. FIG. 5 is a diagram illustrating the spraying mode of the fuel injection valve of the first embodiment of the present invention as seen from the X-axis direction. FIG. 4 shows the way the spraying is performed as seen from the −Y-direction, FIG. 5 shows the way the spraying is performed as seen from the +X-direction.

Due to the above arrangement of the injection holes and the inclination direction of the injection holes, when seen from the −Y-direction, the spray ejected from the nozzle plate 6 form sprays 31 and 32 in two directions. That is, the fuel having passed the injection holes 7a, 7b, 7c, 7d, 7e, and 7f forms the spray 31, and the fuel having passed the injection holes 7a′, 7b′, 7c′, 7d′, 7e′, and 7f′ forms the spray 32. Further, when seen from the +X-direction, there is formed a spray in one direction. In this way, in the present construction, it is possible to form sprays in two directions, which is to be aimed at.

Further, in the above construction, it is possible to promote atomization of the fuel. In the following, the atomization mechanism in the present embodiment will be described.

In the following, a comparative example related to the present invention will be described. The components that are the same as those of the first embodiment will be indicated by the same reference numerals, and a description thereof will be left out.

FIG. 6 is a diagram illustrating the nozzle plate 6′ of a fuel injection valve according to a first comparative example of the present invention as seen from the valve body side. In particular, in the comparative example of FIG. 6, there is shown a nozzle plate 6′ inclined such that the outlet surfaces of the injection holes 7′ are situated on the center side of the nozzle plate 6′ with respect to the inlet surfaces. That is, there is shown a nozzle plate 6′ in which the injection holes 7′ are inclined so as to be opposite the fuel flow direction 18 flowing into the injection holes 7′.

As in the first embodiment, also in the present comparative example, all the injection holes 7′ are arranged in the circumference of the arrangement circle 80′ the center of which is the center O′ of the nozzle plate 6′.

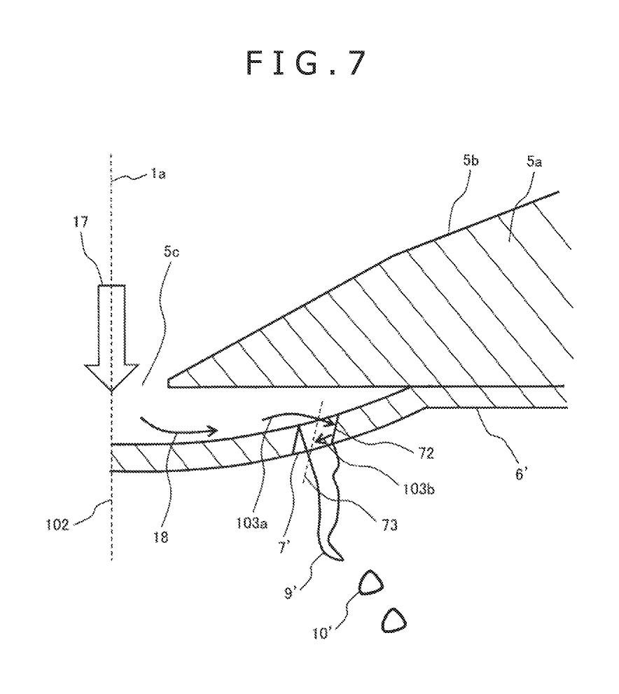

In the case where projection is made onto a plane similar to the section A-A of FIG. 2 (the plan view of FIG. 6), the injection holes 7′ are inclined such that the fuel flow direction 11′ flowing through the injection holes 7′ and the fuel flow direction 18 before flowing into the injection holes 7′ are opposite each other and overlap each other. In this case, the center axes 73 (see FIG. 7) of the injection holes 7′ overlap the fuel flow direction 18.

FIG. 7 shows the portion in the vicinity of the injection hole at this time. FIG. 7 is a diagram illustrating a flowing place in the vicinity of an injection hole 7′ of the fuel injection valve of the first comparative example of the present invention.

In this case, the fuel 17 having passed the opening 5c of the fuel path portion collides with the upper surface of the nozzle plate 6′, and forms a flow 18 at high speed along the wall surface of the nozzle plate 6′. Then, it flows into the injection hole 7′. At this time, the injection hole 7′ is inclined so as to be opposite the flow 18, so that the fuel 103a having flowed into the injection hole 7′ collides with the wall surface 72 of the injection hole 7′, and there is induced within a plane perpendicular to the center axis 73 of the injection hole 7′ a flow 103b having a large velocity component. That is, the flow 103b has a large velocity component in the peripheral direction and the radial direction of the injection hole 7′.

As a result, when the fuel forms the liquid film 9′ under the injection hole, it is likely to be divided into droplets 10′, thus promoting atomization. It should be noted, however, that while the injection hole arrangement and the injection hole inclination direction shown in FIG. 6 promote atomization, it is difficult to form sprays in two directions since all the injection holes 7′ are directed to the center of the nozzle plate 6′.

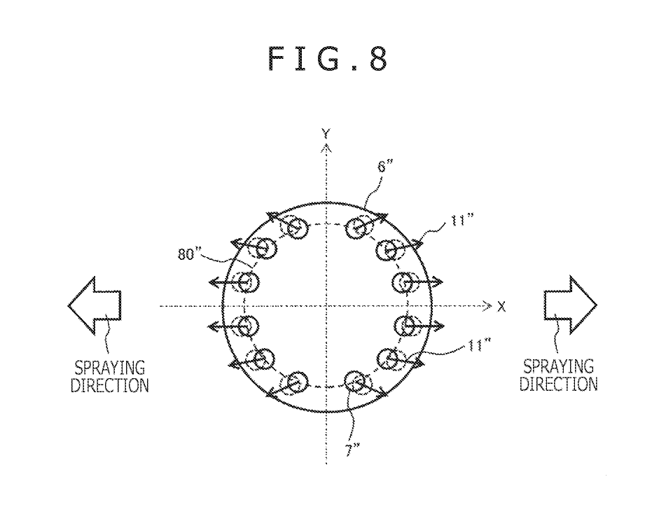

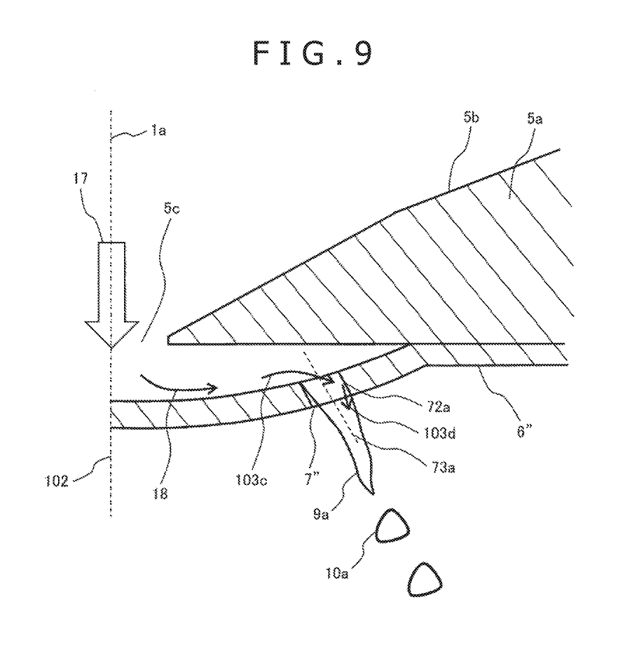

Next, the nozzle plate 6″ of the second comparative example of the present invention will be described with reference to FIGS. 8 and 9. FIG. 8 is a diagram illustrating the nozzle plate 6″ of a fuel injection valve according to the second comparative example of the present invention as seen from the valve body side. FIG. 9 is a diagram illustrating a flowing place in the vicinity of an injection hole of the fuel injection valve of the second comparative example of the present invention. The components that are the same as those of the first embodiment and the first comparative example are indicated by the same reference numerals, and a description thereof will be left out.

In the second comparative example, in order to form sprays in two directions, from the inlet surface toward the outlet surface of the injection hole 7″, the injection hole 7″ is inclined so as to be spaced away from the center of the nozzle plate 6″. In this case, as shown in FIG. 9, the inclination direction of the injection hole 7″ with respect to the main flow direction 18 is not optimum, and the force with which the fuel 103c flowing into the injection hole 7″ collides with the injection hole wall surface 72a is weak, so that the flow velocity in the plane perpendicular to the center axis 73a of the injection hole 7″ is low, and the fuel flows within the injection hole 7″ along the injection hole inclination as indicated by the flow 103d. That is, the fuel flow exhibits a small in-plane direction velocity component and a large axial direction velocity component. As a result, the velocity component in the peripheral direction and the radial direction within the injection hole 7″ is small, so that the liquid film 9a on the downstream side of the injection hole 7″ does not easily expand, resulting in deterioration in the particle size of the droplets 10a divided from the liquid film 9a.

Thus, to promote the atomization, it is desirable for the injection hole to be inclined as much as possible so as to be opposite the flow of the fuel flowing into the injection hole. However, when the injection hole is inclined so as to be completely opposite the liquid flow flowing into the injection hole, it is difficult to form sprays in two directions. On the other hand, when the injection hole is inclined in the same direction as the fuel flow flowing into the injection hole in the inclination direction, that is, outwardly with respect to the center of the nozzle plate, it is easy to form sprays in two directions. The atomization, however, is hard to realize.

In the nozzle plate 6 of the present embodiment, the injection holes 7a through 7f and 7a′ through 7f′ are arranged such that the distance between the first injection hole set and the second injection hole set, that is, the distance between the injection hole 7c (7c′) and 7d (7d′), is larger than the maximum inter-hole distance, of the maximum inter-hole distance between the injection holes 7a through 7c in the first group and the maximum inter-hole distance between the injection holes 7e and 7f in the second group. Further, in the nozzle plate 6 of the present embodiment, the injection holes 7a through 7f and 7a′ through 7f′ are inclined such that the outlet surfaces approach a plane including the center axis 102 of the nozzle plate 6 with respect to the inlet surfaces. This plane is a plane including the center axis 102 and the X-axis. Due to this construction, it is possible to realize spraying in two directions, and further, to promote atomization.

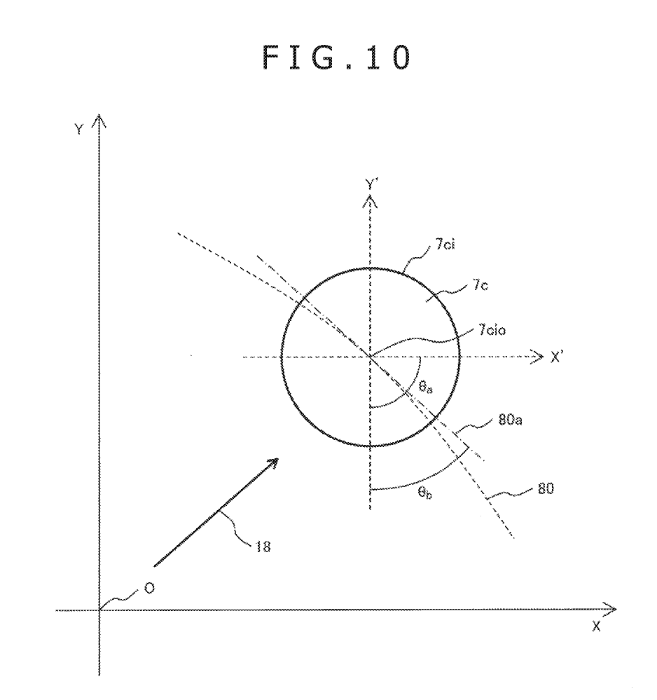

The injection hole inclination direction will be described more specifically. FIG. 10 is an enlarged view of the portion in the vicinity of the injection hole 7c when the nozzle plate 6 of the fuel injection valve 1 according to the first embodiment of the present invention is seen from the valve body 3 side.

The injection holes 7a and 7b are of the same concept as the injection hole 7c described below. The injection holes 7d, 7e, and 7f are in plane symmetry with the injection holes 7a, 7b, and 7c with respect to a plane passing the X-axis and perpendicular to the plane of the drawing (a plane passing the X-axis and perpendicular to the Y-axis).

The axis passing the center 7cio of the inlet surface 7ci of the injection hole 7c and parallel to the X-axis will be referred to as the X′-axis, and the axis passing the center 7cio of the inlet surface 7ci of the injection hole 7c and parallel to the Y-axis will be referred to as the Y′-axis. The circle passing the center 7cio of the inlet surface 7ci of the injection hole 7c and having the origin O of the X-axis and the Y-axis as its center will be referred to as the arrangement circle 80.

In the present embodiment, the inclination angle of the injection hole 7c is set to the range θa of FIG. 10. That is, the injection hole 7c is inclined so as to be directed to the angle range formed by the portion of the X′-axis in which X′>0 and the portion of the Y′-axis in which Y′<0 (the angle range where X′>0 and Y′<0). The X′-axis and the Y′-axis are not included in the above angle range.

By inclining the injection hole 7c as described above, the center of the outlet surface of the injection hole 7c is situated in the range of the X′-axis where X′>0 and in the range of the Y′-axis where Y′<0. As a result, it is possible to form spraying in two directions and to promote the atomization. In this setting of the inclination angle, the X′-axis and the Y′-axis are not included in the setting range of the center position of the outlet surface of the injection hole 7c.

When the synthetic (total) ejecting direction of the spray ejected from the injection holes 7a through 7f arranged in the first injection hole set 7A is projected onto FIG. 3, this ejecting direction extends in the positive direction along the X-axis of FIG. 3. When the synthetic (total) ejecting direction of the spray ejected from the injection holes 7a′ through 7f′ arranged in the second injection hole set 7B is projected onto FIG. 3, this ejecting direction extends in the negative direction along the X-axis of FIG. 3. Thus, by excluding the X′-axis from the setting range of the center position of the outlet surface of the injection hole 7c (that is, by excluding the X′-axis from the inclination direction of the injection hole 7c), it is possible to greatly incline the injection hole 7c with respect to the ejecting direction of the first fuel spray formed by the first injection hole set 7A. As a result, the inclination angle of the injection hole 7c can be made larger with respect to the flowing direction of the fuel flowing into the injection hole 7c.

On the other hand, when the Y′-axis is included in the setting range of the center position of the outlet surface of the injection hole 7c (that is, when the Y′-axis is included in the inclination direction of the injection hole 7c), the ejecting direction of the injection hole 7c is a direction parallel to a plane passing the Y-axis of FIG. 3 and perpendicular to the plane of FIG. 10 (a plane passing the Y-axis and perpendicular to the X-axis). Thus, the spray ejected from the first injection hole set 7A is ejected parallel to the spray ejected from the first injection hole set 7B. As shown in FIG. 4, in the present embodiment, in order that the first fuel spray and the second fuel spray may be separated from each other on the front side (downstream side) of the ejecting direction, the Y′-axis is not included in the setting range of the center position of the outlet surface of the injection hole 7c (That is, the Y′-axis is not included in the inclination direction of the injection hole 7c).

However, for example, the synthetic (total) ejecting direction of the spray ejected from the injection holes 7a through 7f arranged in the first injection hole set 7A is set as a direction parallel to the Y-axis of FIG. 3 and directed toward the positive direction of the Y-axis, and the synthetic (total) ejecting direction of the spray ejected from the injection holes 7a′ through 7f′ arranged in the second injection hole set 7B is set as a direction parallel to the Y-axis of FIG. 3 and directed toward the negative direction of the Y-axis, whereby it is possible to form sprays in two directions similar to those shown in FIG. 4. In this case, it is possible to include the Y′-axis in the setting range of the center position of the outlet surface of the injection hole 7c (That is, it is possible to include the Y′-axis in the inclination direction of the injection hole 7c).

Further, it is advisable to set the inclination angle of the injection hole 7c restrictively to the range of θb. That is, the injection hole 7c is inclined so as to be directed to the angle range made by the tangent 80a at the injection hole center position of the arrangement circle 80 and the portion of the Y′-axis where Y′<0. This angle range is an angle range configured within a range where Y′<0. At this time, the center of the outlet surface of the injection hole 7c is situated in the range where Y′<0 and in the range between the tangent 80a and the portion of the Y′-axis where Y′<0. As a result, it is possible to further promote the atomization. In this case, the injection hole 7c may be inclined along the tangent 80a. At this time, the center of the outlet surface of the injection hole 7c is arranged on the tangent 80a.

The angle range θb made by the tangent 80a and the portion of the Y′-axis where Y′<0 substantially coincides with the range where X′>0 and the range on the inner side of the arrangement circle 80. Thus, the injection hole 7c may be inclined in the range where X′>0 and the range on the inner side of the arrangement circle 80. In this case, the center of the outlet surface of the injection hole 7c is situated in the range where X′>0 and the range on the inner side of the arrangement circle 80.

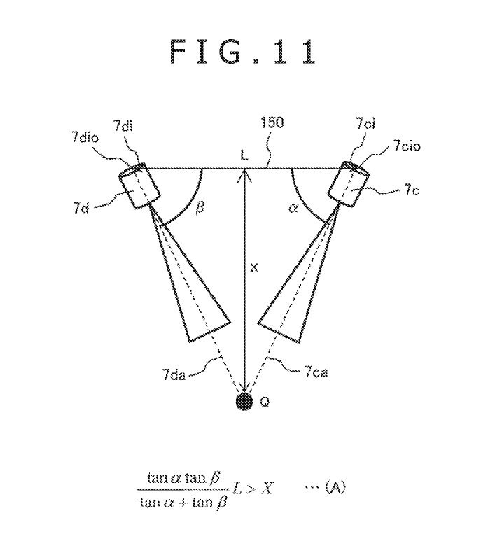

When the spray ejected from the injection hole 7c of the first group 7A1 and the spray ejected from the injection hole 7d of the second group 7A2 interfere with each other directly below the injection holes, there is the possibility of the atomization performance being deteriorated. FIG. 11 is a schematic diagram illustrating the relationship between the inclination angle of the injection hole and the spray interference distance as seen in the section B-B of FIG. 3.

In the present embodiment, there are formed combinations of injection holes in which the mutual center axes 71 are arranged so as to cross each other between the injection holes 7a through 7c of the first group 7A1 and the injection holes 7d through 7f of the second group 7A2. Of the injection hole combinations in which the mutual center axes 71 cross each other, the combination of the injection hole 7c and the injection hole 7d is the combination in which the inter-center distance L is minimum.

Assuming that the inclination of the injection hole 7c in the section B-B in the horizontal direction is a, that the inclination of the injection hole 7d with respect to the horizontal direction is 3, that the inter-center distance of the injection hole 7c and the injection hole 7d is L, the point at which the center axis 7ca of the injection hole 7c and the center axis 7da of the injection hole 7d intersect with each other is Q, and that the distance in the height direction between the straight line (segment) 150 connecting the center 7cio of the inlet surface 7ci of the injection hole 7c and the center 7dio of the inlet surface 7di of the injection hole 7d (the length of the normal extending to the straight line 150) is X, X is expressed by equation (1).

$$\begin{matrix}[ Formula 1 ] & \\ \frac{tan α tan β}{tan α + tan β} L = X & ( 1 )\end{matrix}$$

At this time, when a and 3 are set such that X is 2 mm or more, it is possible to suppress the influence of the spray interference and to promote the atomization. More preferably, X is 5 mm or more, and, most preferably, X is 7 mm or more.

In the case where the construction of the fuel injection valve of Patent Document 1 is applied to the present embodiment, the distance (inlet surface inter-center distance) between the injection hole 7a (7f) situated at the end of the first injection hole set 7A in the circumference of the arrangement circle 80 and the injection hole 7a′ (7f′) situated at the end of the second injection hole set in the circumference of the arrangement circle 80 is larger than the interval (inlet surface inter-center distance) of the injection holes 7a through 7f in the first injection hole set 7A and the interval (inlet surface inter-center distance) of the injection holes 7a′ through 7f′ in the second injection hole set 7B.

On the other hand, in the present embodiment, the inter-center distance of the inlet surfaces of the injection holes is set such that the inter-group inter-hole distance L that is the minimum of the first injection hole set 7A and the inter-group inter-hole distance L that is the minimum of the second injection hole set 7B are larger than the inter-center distance of the inlet surfaces of the two injection holes 7a (7f) and the 7a′ (7f′) closest to each other between the plurality of injection holes 7a through 7f constituting the first injection hole set 7A and the plurality of injection holes 7a′ through 7f′ constituting the second injection hole set 7B.

That is, in the present embodiment, the two injection holes the inlet surface inter-center distance (L) of which set large exist in the same injection hole set. As described above, this is due to the fact that the center axes of the injection holes of the same injection hole set are inclined so as to approach each other on the front side of the ejecting direction. This construction is adopted in order to prevent a plurality of sprays from colliding each other at a position close to the injection holes.

Also in the fuel injection valve 1 of the present embodiment, the inter-center distance between the inlet surface of the injection hole 7a situated at the end of the first injection hole set 7A in the circumference of the arrangement circle 80 and the inlet surface of the injection hole 7a′ situated at the end of the second injection hole set 7B in the circumference of the arrangement circle 80 may be larger than the inter-center distance 1 of the inlet surfaces of the other injection holes. The inter-center distance between the inlet surface of the injection hole 7f situated at the end of the first injection hole set 7A in the circumference of the arrangement circle 80 and the inlet surface of the injection hole 7f′ situated at the end of the second injection hole set 7B in the circumference of the arrangement circle 80 may be larger than the inter-center distance 1 of the inlet surfaces of the other injection holes.

However, to make the inter-center distance L between the inlet surface of the injection hole 7c, 7c′ and the inlet surface of the injection hole 7d, 7d′, there is limitation to the space for the arrangement of the injection holes 7 in the circumference of the arrangement circle 80. Thus, it is desirable that that the inter-center distance between the inlet surface of the injection hole 7a and the inlet surface of the injection hole 7a′ and the inter-center distance between the inlet surface of the injection hole 7f and the inlet surface of the injection hole 7f′ be smaller than the inter-center distance L.

### Embodiment 2

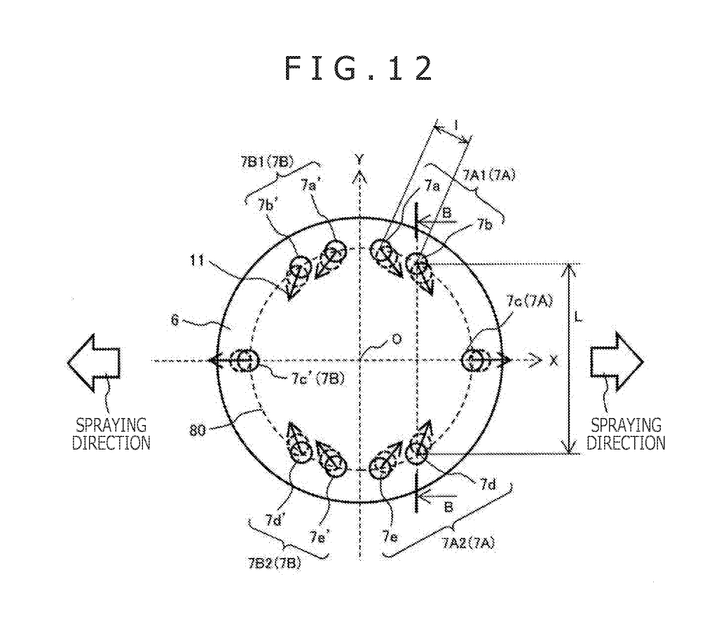

Next, the second embodiment of the present invention will be described with reference to FIG. 12. FIG. 12 is a diagram illustrating the nozzle plate 6 of the fuel injection valve 1 according to the second embodiment of the present invention as seen from the valve body 3 side. The components that are the same as those of the first embodiment are indicated by the same reference numerals, and a description thereof will be left out.

The difference of the present embodiment from the first embodiment is that the injection holes 7c and 7c′ are arranged in the X-axis and that the inclination direction of the injection holes 7c and 7c′ is directed radially outwards with respect to the center of the nozzle plate 6. In this case, the injection holes are arranged such that the distance between the injection hole 7b and the injection hole 7d (the inter-center distance between the inlet surface of the injection hole 7b and the inlet surface of the injection hole 7d) L is larger than the distance between the injection hole 7a and the injection hole 7b (the inter-center distance between the inlet surface of the injection hole 7a and the inlet surface of the injection hole 7b) 1.

The injection holes 7a′, 7b′, 7c′, 7d′, and 7e′ are in plane symmetry with the injection holes 7a, 7b, 7c, 7d, and 7e with respect to a plane passing the Y-axis and perpendicular to the plane of FIG. 12 (a plane including the Y-axis and the center axis line 1a, or a plane passing the Y-axis and perpendicular to the X-axis). The injection holes 7d and 7e are in plane symmetry with the injection holes 7a and 7b with respect to a plane passing the X-axis and perpendicular to the plane of the drawing (a plane including the X-axis and the center axis line 1a, or a plane passing the X-axis and perpendicular to the Y-axis).

In the case of the present embodiment, the center axis (ejecting direction) of the injection hole 7c exhibits the maximum X coordinate value of the first injection hole set 7A. Further, the center axis (ejecting direction) of the injection hole 7c exists in a plane passing the X-axis and perpendicular to the Y-axis, so that it does not cross the center axes of the other injection holes 7a, 7b, 7d, and 7e of the first injection hole set 7A. Like the injection hole 7c of the first injection hole set 7A, the center axis (ejecting direction) of the injection hole 7c′ of the second injection hole set 7B does not cross the center axes of the other injection holes 7a′, 7b′, 7d′, and 7e′ of the second injection hole set 7B. Thus, there is no need in particular for the injection hole 7c and the injection hole 7c′ to take into consideration the distance to the other injection holes.

The center axis (ejecting direction) of the injection hole 7c of the first injection hole set 7A may cross the center axes of the other injection holes 7a, 7b, 7d, and 7e of the first injection hole set 7A. In this case, however, it is necessary to take into account the inter-hole distance or the injection hole inclination angle so that the positions where the center axis of the injection hole 7c crosses the center axes of the other injection holes 7a, 7b, 7d, and 7e may be spaced away to some degree from the outlets of the injection holes. The center axis (ejecting direction) of the injection hole 7c′ of the second injection hole set 7B may cross the center axes of the other injection holes 7a′, 7b′, 7d′, and 7e′ of the second injection hole set 7B. In this case, however, it is necessary to take into account the inter-hole distance or the injection hole inclination angle so that the positions where the center axis of the injection hole 7c′ crosses the center axes of the other injection holes 7a′, 7b′, 7d′, and 7e′ may be spaced away to some degree from the outlets of the injection holes.

The injection holes 7a, 7b, 7d, and 7e and the injection holes 7a′, 7b′, 7d′, and 7e′ are injection holes arranged in plane symmetry with respect to a plane passing the Y-axis and perpendicular to the X-axis. With respect to the injection holes thus arranged with the X-axis therebetween, the inlet surface inter-center distance must be set as described above.

In the structure of the present embodiment, the injection holes 7c and 7c′ can easily form a two-way spray, and, as in the first embodiment, the injection holes 7a, 7b, 7d, 7e, 7a′, 7b′, 7d′, and 7e′ can promote the atomization. That is, the role allotment is established as follows: the injection holes 7c and 7c′ form a two-way spray, and the injection holes 7a, 7b, 7d, 7e, 7a′, 7b′, 7d′, and 7e′ promote the atomization. Due to this arrangement, it is advantageously possible to facilitate the control of the spraying angle.

### Embodiment 3

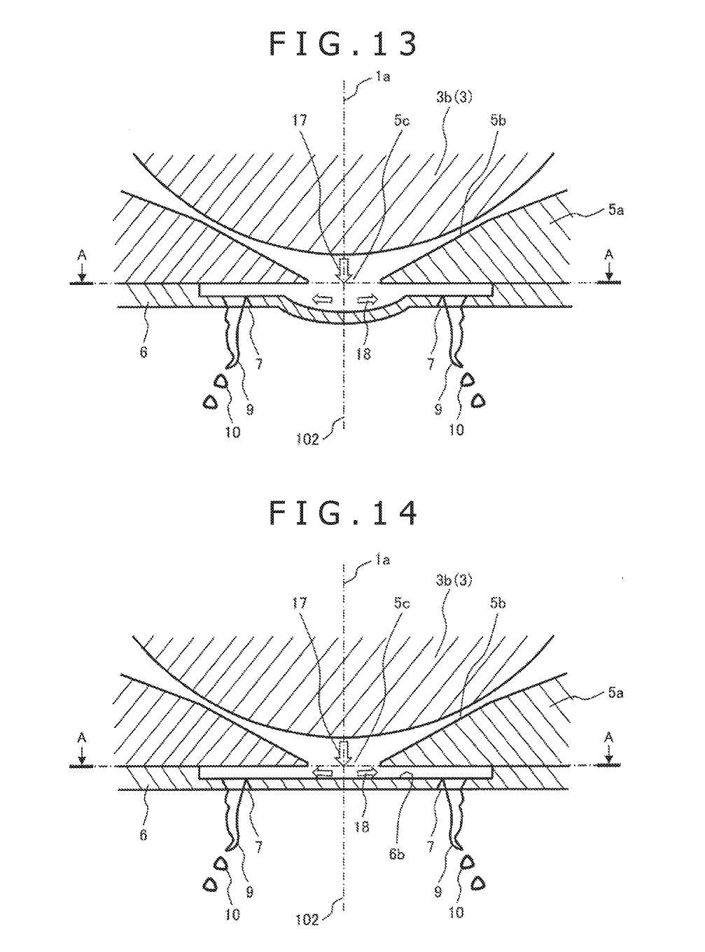

The third embodiment of the present invention will be described with reference to FIG. 13. FIG. 13 is an enlarged sectional view of the portion in the vicinity of the distal end portion 3b of the valve body 3 of the fuel injection valve 1 according to the third embodiment of the present invention. The components that are the same as those of the first embodiment and the second embodiment are indicated by the same reference numerals, and a description thereof will be left out.

In the first embodiment described above, the nozzle plate 6 has the downwardly convex configuration 6a. In the present embodiment, the portion of the nozzle plate 6 near the center thereof (the portion in the vicinity of the center axis 102 and opposite the opening 5c) exhibits a downwardly convex configuration 6a, whereas the portion where the injection holes 7 are formed of a planar structure. Otherwise, this embodiment is of the same construction as the first embodiment and the second embodiment.

In this structure, the fuel having passed between the valve seat surface 5b and the distal end portion 3b of the valve body 3 passes through the opening 5c, and collides with the upper surface of the nozzle plate 6 from the direction of the arrow 17. After this, as indicated by the arrow 18, the fuel flows from the center of the nozzle plate 6 radially outwards along the surface of the nozzle plate 6. Since the portion of the nozzle plate 6 near the center is of a downwardly convex configuration 6a, the velocity of the fuel near the surface of the nozzle plate is high. After passing the injection holes 7, the fuel forms the liquid films 9, which are divided into the droplets 10 due to instability because of the capillary wave and the shearing force with respect to the air, thus attaining atomization of the fuel.

By thus providing the downwardly convex configuration 6a, it is possible to increase the velocity in the vicinity of the surface of the nozzle plate 6 and to promote the atomization. By forming the portion where the injection holes 7 are installed in a planar structure, the machining accuracy of the injection holes 7 is improved, and the control of the fuel spraying direction is facilitated. At the same time, it is possible to diminish the interval between the nozzle plate 6 and the seal member 5a, and to diminish the volume of the space surrounded by the nozzle plate 6, the valve seat surface 5b, and the valve body 3. By thus diminishing the volume, it is possible to accurately spray the fuel in the target amount.

### Embodiment 4

The fourth embodiment of the present invention will be described with reference to FIG. 14. FIG. 14 is an enlarged sectional view of the portion in the vicinity of the distal end portion 3b of the valve body 3 of the fuel injection valve 1 according to the fourth embodiment of the present invention. The components that are the same as those of the first through third embodiments are indicated by the same reference numerals, and a description thereof will be left out.

As shown in FIG. 14, in the present embodiment, the portion of the nozzle plate 6 in the vicinity of the center axis 102 and opposite the opening 5c is formed as a flat surface. That is, the nozzle plate 6 as a whole is formed as a flat plate having no downwardly convex configurations 6a. In the present embodiment, instead of the downwardly convex configuration 6a, there is formed a recess 6b expanding radially outwards from the portion in the vicinity of the center axis 102 and opposite the opening 5c. At the bottom surface of the recess 6b, there are provided the injection holes 7 the inlet surfaces of which are open.

Otherwise, this embodiment is of the same construction as the first through third embodiments.

In this case, the control of the fuel spraying direction is facilitated, and the machining is very easy to perform.

### Embodiment 5

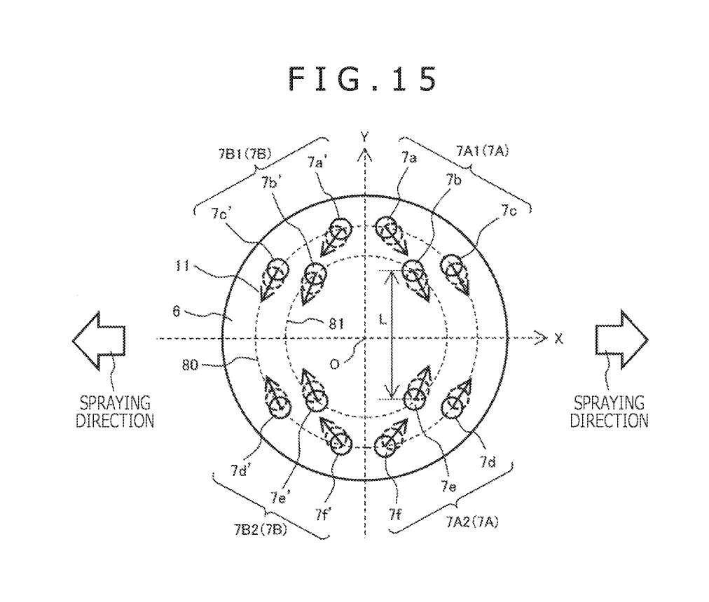

The fourth embodiment of the present invention will be described with reference to FIG. 15. FIG. 15 is a diagram illustrating the nozzle plate 6 of the fuel injection valve 1 according to the fifth embodiment of the present invention as seen from the valve body 3 side. The components that are the same as those of the first through third embodiments are indicated by the same reference numerals, and a description thereof will be left out.

In embodiment 1 described above, all the injection holes 7 are arranged in the same arrangement circles. In the present embodiment, the injection holes 7 are arranged in a plurality of arrangement circles 80, 81.

As the first group 7A1 of the first injection hole set 7A, there are provided the injection holes 7a, 7b, and 7c. As the second group 7A2 of the first injection hole set 7A, there are provided the injection holes 7d, 7e, and 7f. As the first group 7B1 of the second injection hole set 7B, there are provided the injection holes 7a′, 7b′, and 7c′. As the second group 7B2 of the second injection hole set 7B, there are provided the injection holes 7d′, 7e′, and 7f′.

In this case, the inter-group distance in the injection hole set is the distance L between the injection holes 7b, 7b′ and the injection holes 7e, 7e′, and the injection holes 7 are arranged such that L is larger than the maximum inter-hole distance (the inter-center distance of the injection hole inlet surfaces) of the injection holes 7a through 7c, 7d through 7f, 7a′ through 7c′, and 7d′ through 7f′ constituting the groups in the injection hole sets.

Due to this construction, it is possible to attain the same effect as that of embodiment 1, and the control of the spraying angle is facilitated.

Further, by enlarging the inter-group distance L, the injection hole arrangement space in one arrangement circle 80 is diminished. Thus, a plurality of injection holes 7 are arranged in the plurality of arrangement circles 80 and 81 in a dispersed fashion, whereby it is possible to arrange a large number of injection holes. Or, it is possible to prevent concentration of a large number of injection holes in a small space, so that the strength of the nozzle plate 6 is not lowered.

Also in the present embodiment, with respect to the inclination direction of the injection holes 7, it is advisable to apply the angle ranges ea and 8b described with reference to FIG. 10. Further, the injection holes 7c and 7c′ of the second embodiment and the nozzle plate 6 of the third and fourth embodiment may be applied.

The present invention is not restricted to the embodiments described above but includes various modifications. For example, while the above embodiments are described in detail in order to facilitate the understanding of the present invention, the present invention is not always restricted to a construction equipped with all the components described above. Further, it is possible to replace a part of the construction of a certain embodiment by the construction of another embodiment, and it is also possible to add the construction of another embodiment to the construction of a certain embodiment. Further, with respect to a part of the construction of each embodiment, addition, deletion, and replacement of another construction are possible.

### DESCRIPTION OF REFERENCE CHARACTERS

1: Fuel injection valve
1a: Center axis of the fuel injection valve
2: Casing
2a: Fuel supply port
3: Valve body
4: Anchor
5: Nozzle body
5b: Valve seat surface
5c: Opening
6: Nozzle plate
6a: Downwardly convex configuration
7, 7a, 7b, 7c, 7d, 7e, 7f, 7a′, 7b′, 7c′, 7d′, 7e′: Injection hole
11: Injection hole inclination direction
12: Spring
13: Spring adjuster
14: Solenoid coil
15: Yoke
17: Fuel flow at the opening of a fuel path portion arranged on the downstream side of the valve member
18: Fuel flow constituting the main flow on the nozzle plate
72, 72a: Collision surface of the fuel flow in the injection hole
71, 73, 73a: Injection hole center axis
80, 81: Arrangement circle
102: Nozzle plate center axis
103a, 103b, 103c, 103d: Flow in the vicinity of and within the injection hole

1. A fuel injection valve comprising a valve body that can be displaced in a center axis line direction, a valve seat opening and closing a fuel path in cooperation with the valve body, and a plurality of injection holes provided on a downstream side of the valve seat and configured to eject a fuel having passed through the fuel path to exterior, wherein the fuel ejected from the plurality of injection holes of a first injection hole set formed by a plurality of injection holes being at least a part of the plurality of injection holes forms a first fuel spray directed in a first spraying direction, wherein
supposing that the plurality of injection holes constituting the first injection hole set and the first spraying direction in which the first fuel spray is directed are projected on an imaginary plane orthogonal to the center axis line direction, and that an imaginary orthogonal coordinate system which has an imaginary X-axis extending along the first spraying direction and an imaginary Y-axis orthogonal to the imaginary X-axis and which has an origin coinciding with a projection center point obtained through projection of the center axis line onto the imaginary plane is imagined in the imaginary plane, then,
in the imaginary plane, the plurality of injection holes constituting the first injection hole set are formed such that an injection hole center axis extending from an inlet surface toward an outlet surface of the injection hole is formed to extend in a direction different from that of a straight line connecting the origin of the imaginary orthogonal coordinate system and a center of the inlet surface and that a center of the outlet surface is situated close to the imaginary X-axis with respect to the center of the inlet surface.

2. The fuel injection valve according to claim 1, wherein
the plurality of injection holes constituting the first injection hole set are divided into a plurality of injection holes constituting a first group and a plurality of injection holes constituting a second group, with the imaginary X-axis serving as a boundary, and
an inter-group inter-hole distance that is minimum of inter-group inter-hole distances formed between the centers of the inlet surfaces of the injection holes between the plurality of injection holes constituting the first group and the plurality of injection holes constituting the second group is set to be larger than maximum in-group inter-hole distance of in-group inter-hole distances formed between the centers of the inlet surfaces of the injection holes between the plurality of injection holes constituting the first group and in-group inter-hole distances formed between the centers of the inlet surfaces of the injection holes between the plurality of injection holes constituting the second group.

3. The fuel injection valve according to claim 2, further comprising a second injection hole set forming a second fuel spray directed in a second spraying direction different from the first spraying direction, wherein
the second injection hole set has a plurality of injection holes divided into a plurality of injection holes constituting a third group and a plurality of injection holes constituting a fourth group, with the imaginary X-axis being a boundary,
the plurality of injection holes constituting the first group are arranged in a first quadrant of the imaginary orthogonal coordinate system,
the plurality of injection holes constituting the third group are arranged in a second quadrant of the imaginary orthogonal coordinate system,
the plurality of injection holes constituting the fourth group are arranged in a third quadrant of the imaginary orthogonal coordinate system,
the plurality of injection holes constituting the second group are arranged in a fourth quadrant of the imaginary orthogonal coordinate system, and
an inter-group inter-hole distance that is minimum of inter-group inter-hole distances formed between the centers of the inlet surfaces of the injection holes between the plurality of injection holes constituting the third group and the plurality of injection holes constituting the fourth group is set to be larger than maximum in-group inter-hole distance of in-group inter-hole distances formed between the centers of the inlet surfaces of the injection holes between the plurality of injection holes constituting the third group and in-group inter-hole distances formed between the centers of the inlet surfaces of the injection holes between the plurality of injection holes constituting the fourth group.

4. The fuel injection valve according to claim 3, wherein the plurality of injection holes constituting the third group and the plurality of injection holes constituting the fourth group are arranged in plane symmetry with the plurality of injection holes constituting the first group and the plurality of injection holes constituting the second group with respect to a plane passing the imaginary Y-axis and perpendicular to the imaginary X-axis.

5. The fuel injection valve according to claim 3, wherein the plurality of injection holes of the first injection hole set and the plurality of injection holes of the second injection hole set are arranged such that the centers of the inlet surfaces are situated in a circumference of an arrangement circle a center of which is the origin; and
at least one of the plurality of injection holes is inclined such that the center of the outlet surface is situated within a range on an inner side of the circumference of the arrangement circle.

6. The fuel injection valve according to claim 3, wherein the plurality of injection holes of the first injection hole set and the plurality of injection holes of the second injection hole set are arranged in a circumferences of a plurality of arrangement circles.

7. The fuel injection valve according to claim 4, wherein the inter-group inter-hole distance that is minimum of the first injection hole set and the inter-group inter-hole distance that is minimum of the second injection hole set are larger than an inter-center distance of the inlet surfaces of two injection holes closest to each other between the plurality of injection holes constituting the first injection hole set and the plurality of injection holes constituting the second injection hole set.
